(19) United States
(12) Patent Application Publication
(10) Pub. No.: US 2021/0259242 A1
(43) Pub. Date: Aug. 26, 2021

(54) NOVEL PLANT ESSENTIAL OIL AND WAX FORMULATIONS FOR USE AS PESTICIDES AND PLANT BIOSTIMULANTS

(71) Applicant: Circadian Crop Sciences LLC, Davis, CA (US)

(72) Inventor: Ronald Edwin Lane, Colfax, CA (US)

(73) Assignee: Circadian Crop Sciences LLC, Davis, CA (US)

(21) Appl. No.: 16/798,380

(22) Filed: Feb. 23, 2020

(51) Int. Cl. A01N 31/02; A01N 25/32; A01N 65/22; A01N 65/44; A01N 27/00

(52) U.S. Cl. CPC A01N 31/02; A01N 25/32; A01N 27/00; A01N 65/44; A01N 65/22

(57) ABSTRACT

The present invention relates to the infusion of polycosanols, including triacontanol (C30-OH), into essential-oil-based pesticides for the purpose of mitigating phytotoxicity inherent in essential-oil-based pesticides and for introducing the plant biostimulant triacontanol (C30-OH). Such formulations are typically combined with one or more emulsifier and water and applied to plants as a spray or fog to foliage, or pruning cuts, or as a root zone drench, or to seeds, for purposes of insect and disease suppression, and for increasing plant growth and/or yields and/or quality of yields and/or stimulating an immune response for controlling diseases. All claims for such benefits of essential oils as pesticides and of triacontanol as a plant biostimulant are supported by numerous studies in peer review journals. The invention improves upon existing essential-oil-based pesticides by reducing phytotoxicity from the addition of waxes, and by introducing the potent plant biostimulant wax, triacontanol.

### FIELD OF THE INVENTION

The present invention relates to the formulation and application of plant biostimulants and pesticides. It builds upon integrating principles of plant physiology, plant protection, agronomy, and agrochemistry.

### BACKGROUND OF INVENTION

Attention first came to the use of triacontanol (CH₃(CH₂₂₈CH₂OH) as a naturally occurring plant biostimulant in the 1970's (Ries, Et al., Science, 195: 1339 (1977)). Subsequently U.S. Pat. No. 4,150,970 by Ries laid claim to dissolving triacontanol in chloroform, benzene, or other unnamed solvents, and emulsifying in water with an emulsifying agent such as Tween 20, and then applying to agricultural crops at rates ranging from 0.4 grams to 40 grams per acre.

Ashmead showed synergistic effects when triacontanol is combined with certain metal proteinates and a variety of other plant growth substances (U.S. Pat. No. 4,169,717). Ashmead does not elaborate on solvents, emulsifiers, wetting agents, or of the polycosanol profile of naturally occurring triacontanol bearing sources.

Welebir claims invention of formulations of triacontanol in combination with polar organic solvents (many of which are harmful to humans and the environment), metal ions, other plant growth substances, and water (U.S. Pat. No. 4,470,840). Plant essential oils are not named as solvents in Welebir's invention, nor are the addition of waxes identified as mitigating the phytotoxic effects of solvents used in his formulations.

Prior patents, formulations described in scientific literature, and commercial agricultural products have failed to take advantage of coupling waxes with plant essential oils to reduce phytotoxicity of essential-oil-based pesticides. Dissolving triacontanol in plant essential oils for providing a plant biostimulant is not described in scientific literature, and commercial agricultural products.

The present invention provides for superior formulations of the plant biostimulant triacontanol, whereby a volatile plant essential oil provides the dual purpose of dissolving natural sources of triacontanol, while imparting pesticidal properties inherent in the essential oil, and whereby complimentary polycosanols and/or other waxes are abundant and counteract phytotoxic effects of volatile plant essential oils.

### SUMMARY OF THE INVENTION

It is the objective of the present invention to increase yields and qualities of agricultural crops using formulations of plant essential oils that are less prone to phytotoxicity due to waxes dissolved therein, and that stimulate positive growth attributes from the presence of triacontanol. Previous inventions have focused upon the positive effects of triacontanol as a plant growth regulator, but many other factors effect plant growth, (insects, diseases, climate, nutrition, and soil to name a few). Previous inventions may specify using a solvent with triacontanol formulations, but the specified solvent serves no purpose other than to dissolve triacontanol, and these solvents most certainly impart a degree of phytotoxicity. In the present invention essential oils serve the dual purpose of solvent/pesticide, and the additional waxes in the formulation reduce phytotoxicity inherent in the application of solvents to plants.

The benefits of triacontanol are well supported in scientific research and include increasing yields of a wide variety of fruits, vegetables, and essential oils, and in increasing flavonoids and carotenoids associated with colors and flavors, and in increasing protein and sugar content of a variety of plant parts (Naeem et al, 2011). In Asia millions of hectares of agricultural crops are treated with triacontanol with numerous purported benefits. Such is not the case in Western Europe and the Americas. This is largely due to an inconsistency of results from scientific studies. Such inconsistencies may be due to triacontanol source, formulating issues, environmental conditions, phytotoxic effects of solvents and emulsifiers offsetting beneficial effects, timing of applications, and other factors. Formulations described by the invention provide consistent results when weekly to bi-weekly applications begin soon after budbreak in perennial crops and shortly after germination in annual crops and continue up until harvest.

As most triacontanol applications are foliar, it makes sense to accomplish additional objectives with each application, such as reducing insect and disease pressure. Essential oils of the present invention serve a dual purpose, acting as both solvent for waxes (including triacontanol) and as pesticides.

Volatile plant essential oils are highly effective solvents of waxes like triacontanol and possess diverse and well documented pesticidal properties. These oils are generally derived from aromatic plants through steam distillation and include volatile oils from: mint, peppermint, lavender, rosemary, sage, garlic, eucalyptus, sweet orange, tea tree, juniper berry, citronella, cedarwood, ginger, jasmine, clove, lemongrass, and cinnamon. It is known by those proficient in the art that applications to plants of solvents capable of dissolving waxes such as triacontanol are also capable of stripping waxes from plants, resulting in plant stress and/or burnt foliage and/or plant death. The invention finds that dissolving waxes within a volatile plant essential oil provides waxes to replace all or a portion thereof of those waxes stripped from plants during foliar applications of essential oils. Thus, the invention improves upon existing pesticide formulations of volatile plant essential oils.

In one embodiment of the invention, a source of triacontanol and other polycosanols is dissolved in peppermint oil, this is copied with a partially saponified vegetable oil and emulsifiers, which is diluted with water and sprayed on cabernet grapevines, which due to climate change failed in previous years to produce sufficient anthocyanins to meet market standards of color. Such foliar applications increase anthocyanin content to meet market standards, while increasing sugar content and overall yield, and while keeping spider mite populations low. This preserves the economic viability and way of life of an entire wine growing region.

In another aspect, triacontanol and other polycosanols are dissolved at high concentration in thyme oil, emulsified, and then diluted with water. This is applied to the fresh pruning wounds of dormant grapevines to prevent stem canker diseases (which can reach 100% in some areas). The essential oil kills fungal spores and leaves behind a protective covering of wax when it evaporates. Rather than acquire stem canker diseases, treated vines remain vigorous for many years after non-treated vines have been removed from the vineyard. In addition, buds that break in the spring are more vigorous from triacontanol absorbed into the vines.

In another embodiment, a paraffinic wax is dissolved in a mixture of rosemary, sweet orange oil, and peppermint oil. This is diluted in water and sprayed bi-weekly on vegetable crops to control insects and plant diseases.

### DETAILED DESCRIPTION OF THE INVENTION

### Definitions

Biostimulant: any natural microorganism or substance that when applied to plants, soils, or substrates—in conjunction with an established fertilization plan—stimulates a natural plant benefit to treated plants.

Polycosanols: are long, straight-chain aliphatic carbon, primary fatty alcohols common in the epicuticular waxes of plants, and are waxes themselves, insoluble in water.

Triacontanol: also referred to as 1-triacontanol, is a straight-chain aliphatic 28-carbon primary fatty alcohol that is common in the epicuticular waxes of plants, and found to have biostimulating effects for a wide range of plants. Triacontanol is a wax and is insoluble in water.

Volatile plant essential oils: are concentrated hydrophobic liquids containing volatile (easily evaporated at normal temperatures) chemical compounds from plants.

### Description

The invention describes plant derived essential oil pesticides with reduced phytotoxicity and with or without triacontanol (C30-OH) as one of the accompanying waxes, and typically combined with emulsifiers, which upon dilution with water is applied to plants as a foliar spray or fog, or as a root zone drench, or to seeds or plant wounds, for purposes of insect and disease suppression and increasing plant growth and/or yields of fruits and of active constituents of essential oils, and/or improving fruit and vegetable quality by increasing flavonoids, carotenoids, and sugar content.

U.S. Pat. Nos. 4,150,970 and 4,169,717 and 4,470,840 describe formulations consisting of triacontanol dissolved in a variety of solvents and coupled with emulsifiers, wetting agents, other plant hormones, and bi and tri-valent metal ions, and with other substances unrelated to this invention. These patents document many of triacontanol's benefits and are the foundation for using triacontanol in agriculture. Using volatile plant essential oils as polycosanol solvents are beyond the scope of their expired patents. Using a solvent that can serve the dual purpose of dissolving triacontanol and serving as a pesticide was not even remotely alluded to. The only polycosanol considered of value in these patents was triacontanol. That polycosanols and other waxes dissolved into their solvents could mitigate phytotoxic effects of solvents was not considered.

Volatile plant essential oils are used in many pesticide products. Those knowledgeable in the art know these pesticides are effective, but are also aware of a tendency to cause phytotoxicity from delaminating layers of epicuticular waxes. To compensate, growers generally apply these chemicals at night. This gives plants time to secrete some degree of replacement wax prior to experiencing the desiccating effects of intense light. None-the-less these plants experience stress. It is part of the discovery of this invention that by adding polycosanols or other waxes to essential oils and then applying them as pesticides, phytotoxic effects are mitigated and the full benefit of a triacontanol application can be realized. This is not just theoretical. We have treated seedlings and tender buds with wax infused essential oil sprays in direct sunlight repeatedly without any discernable phytotoxipity. This is because the essential oil evaporates, leaving behind a protective film of wax to replace the wax removed by the essential oil solvent.

It is part of the discovery of this invention that volatile plant essential oils are highly effective solvents for dissolving waxes such as polycosanols, including triacontanol, and that by using these volatile plant essential oils as triacontanol solvents instead of the likes of acetone, benzene, chloroform, dimethyl sulfoxide, and the other conventional solvents named in prior patents, a dual purpose is served—protecting plants from insects, mites, and disease, while delivering the biostimulating benefits of triacontanol.

Natural sources of triacontanol include but are not limited to: alfalfa, corn meal, corn expeller cake, and beeswax.

### Contribution to the Art

Over forty years have elapsed since the first triacontanol patents were issued, yet wide scale use of triacontanol has failed to materialize on all continents with the exception of Asia. This is despite many published studies supporting triacontanol's benefits. Inconsistent results are generally to blame. This could be due to applying triacontanol at suboptimal rates, or at too late of a stage of crop development, or it could be due to phytotoxic effects of solvents offsetting beneficial effects of triacontanol. Products emulsified to work when mixed with a particular water source, may not perform when diluted with poorer quality water. Failures of triacontanol performance in the experiments of others are hard to explain, but based upon our experience it likely comes down to the afore mentioned factors.

It is the discovery of this invention that triacontanol formulated with other polycosanols dissolved in an essential oil and adequately emulsified and applied on a consistent basis (weekly to bi-weekly) at a bioactive rate (generally 10 to 200 parts per billion triacontanol), starting from young plants, provides consistently positive results, which includes higher yields and better quality. This is without additions of tri and covalent metal ions, or additional hormones described in previous patents.

Using volatile plant essential oils as solvents in triacontanol formulations allows for applications to serve as biostimulants and pesticides, both of which can strongly impact overall plant health.

Pesticides derived from volatile plant essential oils are effective, derived from renewable resources, and safe for humans and the environment when used within reason. Their biggest drawback is a high potential for phytotoxicity. By incorporating polycosanols in addition to triacontanol into volatile plant essential oils, these waxes mitigate the phytotoxic tendency of essential oils.

As the world continues to warm from accumulation of greenhouses gasses in the atmosphere, the ranges where crops are grown will change, and in fact they are already changing. While triacontanol can increase yields, it's most important role may be in helping plants deal with stresses of climate change. Imagine average temperatures in the Napa Valley of California increasing to a point where Cabernet grapes no long produce enough anthocyanins to have enough color to meet marketing standards for such grapes. It would alter the entire economy and culture of the region. Triacontanol has been shown to increase anthocyanins and other flavonoids and has the potential to protect growing regions such as the Napa Valley.

### EXAMPLES

### Example 1

One-thousand grams of corn meal containing 9 parts per million triacontanol and thirty parts per million of total polycosanols, were combined with 1000 milliliters of peppermint oil. Ingredients were blended and then strained through a 300-mesh filter. Emulsifiers were added to the liquid fraction, which contained 11 parts per million of triacontanol. This was mixed with equal parts of a partially saponified corn oil. The resulting solution was applied at rates of 3.9 ounces per gallon of water (165 ppb triacontanol) and 1.3 ounces per gallon of water (55 ppb triacontanol) to hemp plants. Controls received no triacontanol. Foliar sprays of each treatment were made weekly. Following each weekly treatment, plant positions were rearranged in the grow room. Automatic nightly fogging of All Phase (contains potassium sorbate) ensured controls were powdery mildew free. Weekly applications continued for 14 weeks (4 weeks of long days and ten weeks of short days). At harvest the mean fresh weight of foliage was approximately 400 grams for controls, 725 grams for plants treated with 40 ppb of triacontanol, and 800 grams for plants treated with 80 ppb of triacontanol.

### Example 2

One hundred grams of paraffin wax was dissolved in one liter of peppermint oil, to which was added twenty-five grams of sodium lauryl sulfate to act as a surfactant, and then diluted with water at a 1:50 ratio. The resulting solution was sprayed on mature fuschia plants and to cabbage, lettuce, cucumber seedlings to thoroughly wet foliage at midday in full sunlight and with the temperature hovering around 27 degrees Celsius. A second group of the same species were sprayed with the same formulation and dilution, but without the paraffin wax. After 24 hours plants were evaluated for signs of phytotoxicity. Plants treated with the solution containing paraffin wax appeared healthy. Plants of all species treated with the solution lacking paraffin were badly burned. The claimed invention is:

1. A method of stimulating plant growth and development by applying thereto an effective amount of 1-triacontanol (over 1 part per billion in final spray solution) dissolved within a volatile plant essential oil.

2. A method for reducing the phytotoxicity of essential-oil-based pesticides by the addition of waxes (over 1% wax by weight to essential oil).

3. Formulations whereby triacontanol and other waxes are dissolved within a volatile plant essential oil for purposes of serving as both a low phytotoxicity essential oil pesticide and a plant biostimulant.

4. The formulation of claims 1, 2 & 3, wherein the application is to seeds.

5. The formulation of claims 1, 2 & 3, wherein the application is to roots.

6. The formulation of claims 1, 2 & 3, wherein the application is to foliage.

7. The formulation of claims 1, 2 & 3, wherein the application is to pruning cuts.

8. The formulation of claims 1, 2 & 3, wherein the application is to cuttings.
